(19) United States
(12) Patent Application Publication
(10) Pub. No.: US 2004/0015878 A1
(43) Pub. Date: Jan. 22, 2004

(54) Reordering controller, reordering method and storage apparatus

(75) Inventor: Masaki Saito, Kawasaki (JP)

Correspondence Address: Patrick G. Burns, Esq., GREER, BURNS,CRAIN, LTD., 300 South Wacker Dr., Suite 2500, Chicago, IL, 60606, US

(73) Assignee: FUJITSU LIMITED

(21) Appl. No.: 09/957,834

(22) Filed: Sep. 21, 2001

(30) Foreign Application Priority Data
Apr. 10, 2001 (JP) 2001-111919

(51) Int. Cl. G06F 9/44

(52) U.S. Cl. 717/127; 717/159

(57) ABSTRACT

A reordering controller reorders an execution order of instructions. The reordering controller is provided with a function of carrying out an instruction rearranging process to rearrange the instructions and reorder the execution order of the instructions depending on a state of a restoration process in a storage apparatus.

### BACKGROUND OF THE INVENTION

This application claims the benefit of a Japanese Patent Application No.2001-111919 filed Apr. 10, 2001, in the Japanese Patent Office, the disclosure of which is hereby incorporated by reference.

1. Field of the Invention

The present invention generally relates to reordering controllers, reordering methods and storage apparatuses, and more particularly to a reordering controller and a reordering method which optimize an execution order of instructions, and to a storage apparatus which employs such a reordering controller or a reordering method.

2. Description of the Related Art

Recently, in systems formed by a host unit which is typified by a personal computer, and an external storage apparatus which is typified by a magnetic disk unit such as a hard disk drive, there are demands to further improve the system performance. To meet such demands, various functions are being provided in the system. Even in an interface agreement provided for a data communication between the host unit and the external storage apparatus, various functions are provided, and a reordering function is one of the typical functions.

In order to use the reordering function prescribed by the interface agreement, it is necessary for both the host unit and the external storage apparatus to carry out operations corresponding to the reordering function. More particularly, the host unit must hold for a predetermined time instructions which are issued with respect to the external storage apparatus, and recognize whether or not executions of the instructions issued from the host unit have ended. On the other hand, the external storage apparatus which receives from the host unit the instructions in a format which takes into account the reordering function does not need to execute the received instructions in the order received from the host unit, and the instructions may be executed in an order which is changed from the received order so that the instructions are executed under a most efficient condition in the environment of the external storage apparatus.

The function of executing the instructions issued from the host unit by successively changing the order of execution to an order which enables execution of the instructions under the most efficient condition, is the most characterizing feature of the reordering function.

For example, suppose that the host unit issues a write instruction with respect to the external storage apparatus in the environment in which the reordering function is provided. In this case, the host unit first issues a write instruction W#1 for writing 10 blocks from a sector number 0 of the recording medium and a data D#1 with respect to the external storage apparatus. The external storage apparatus which receives the write instruction W#1 and the data D#1 can notify the host unit that the execution of the write instruction W#1 is ended when storing the data D#1 to a buffer memory of the external storage apparatus, that is, at a time when the data D#1 is actually not yet written on the recording medium. After making the end notification to the host unit, the external storage apparatus carries out the actual writing with respect to the recording medium. When the host unit receives the end notification with respect to the write instruction W#1 from the external storage apparatus, the host unit can issue a new write instruction with respect to the external storage apparatus. For example, the host unit issues a write instruction W#2 for writing 1 block from a sector number 100 of the recording medium and a data D#2 with respect to the external storage apparatus. Similarly to the case where the write instruction W#1 is received, the external storage apparatus which receives the write instruction W#2 and the data D#2 notifies the end of execution of the write instruction W#2 to the host unit when the data D#2 is stored in the buffer memory of the external storage apparatus.

In this state, the external storage apparatus is actually accessing a portion corresponding to the sector number 0 of the recording medium responsive to the write instruction W#1, and the write instruction W#2 must be executed after the execution of the write instruction W#1 ends. But at this point in time, the end notification with respect to the write instruction W#2 is received at the host unit, and the host unit can issue a new write instruction with respect to the external storage apparatus. Hence, the host unit issues a write instruction W#3 for writing 10 blocks from a sector number 50 of the recording medium and a data D#3 with respect to the external storage apparatus. Similarly to the cases where the write instructions W#1 and W#2 are received, the external storage apparatus which receives the write instruction W#3 and the data D#3 notifies the end of execution of the write instruction W#3 to the host unit when the data D#3 is stored in the buffer memory of the external storage apparatus.

If the external storage apparatus is still accessing the recording medium responsive to the write instruction W#1 and is accessing the portion corresponding to the sector number 0 of the recording medium when the external storage apparatus receives the write instruction W#3, provided that the write with respect to the write instruction W#1 ended, the moving distance of a head would be shorter for the head to move to the portion corresponding to the sector number 50 responsive to the write instruction W#3 than to move to the position corresponding to the sector number 100 responsive to the write instruction W#2. Hence, when the write with respect to the write instruction W#1 ends, the processing time would be shorter if the write with respect to the write instruction W#2 is executed after executing the write with respect to the write instruction W#3. When switching the execution order of the write instructions in such a manner, the write instruction W#2, the data D#2 of the write instruction W#2, and the data D#3 of the write instruction W#3 still remain within the buffer memory of the external storage apparatus, and the above described switching process is possible for this reason.

On the other hand, suppose that the host unit issues a read instruction with respect to the external storage apparatus. Recently, the external storage apparatus is generally provided with a prereading function (or an advance-reading function), and it is assumed for the sake in the following description that 100 blocks are preread.

First, when the host unit issues with respect to the external storage apparatus a read instruction R#1 to read 10 blocks from a sector number 1000 of the recording medium, the external storage apparatus moves the head to the portion corresponding to the sector number 1000 of the recording medium at the time when the read instruction R#1 is received, and reads a total of 110 blocks by reading the requested 10 blocks from the sector number 1000 and in addition to the preread 100 blocks. After the external storage apparatus notifies the host unit that a data transfer will be made with respect to the host unit using the reordering function, the host unit may then issue with respect to the external storage apparatus a read instruction R#2 to read 10 blocks from a sector number 2000 of the recording medium. In this case, the external storage apparatus notifies the host unit that a data transfer will be made with respect to the host unit using the reordering function, similarly to the case when the read instruction R#1 was received, but while continuing the read responsive to the read instruction R#1.

Thereafter, when the host unit issues with respect to the external storage apparatus a read instruction R#3 to read 1 block from a sector number 1100 of the recording medium, the external storage apparatus notifies the host unit that a data transfer will be made with respect to the host unit using the reordering function, similarly to the case when the read instructions R#1 R#2 were received, but while continuing the read responsive to the read instruction R#1. As a result, the host unit assumes a standby state which waits for the data transfers of the read instructions R#1, R#2 and R#3. On the other hand, the external storage apparatus again recognizes the read instructions when the read instruction R#3 is received, and recognizes that the read instruction R#3 matches a preread portion of the read instruction R#1. The instructions are executed in an order such that the read instruction R#3 is executed after the read instruction R#1, but since the read instruction R#3 matches the preread portion, it is judged that no access is necessary to the sector number 1100 of the recording medium requested by the read instruction R#3. For this reason, the reduction in the processing time can be expected if the read instruction R#3 is executed after the read instruction R#1 because the access to the recording medium will be reduced in this case.

As a result, the external storage apparatus reads 110 sectors from the sector number 1000, and while storing the requested data in the buffer memory of the external storage apparatus, the external storage apparatus notifies the host unit that the data read responsive to the read instruction R#1 will be transferred to the host unit. After the preparations for receiving the data are completed in the host unit, the external storage apparatus transfers the data of the first 10 blocks stored in the buffer memory to the host unit, and notifies the host unit that the execution of the read instruction R#1 is ended at a time when this data transfer ends. The external storage apparatus then notifies the host unit that the data read responsive to the read instruction R#3 will be transferred to the host unit, and after the preparations for receiving the data are completed in the host unit, the external storage apparatus transfers the data of the blocks corresponding to the first 1100 sectors stored in the buffer memory to the host unit.

Simultaneously as this data transfer, that is, when the read responsive to the read instruction R#1 is completed, the external storage apparatus reads 10 blocks from the sector number 2000 of the recording medium responsive to the read instruction R#2. Moreover, while storing the requested data in the buffer memory of the external storage apparatus, the external storage apparatus notifies the host unit that the data read responsive to the read instruction R#2 will be transferred to the host unit. After the preparations for receiving the data are completed in the host unit, the external storage apparatus transfers the data of the first 10 blocks stored in the buffer memory to the host unit, and notifies the host unit that the execution of the read instruction R#2 is ended at a time when this data transfer ends. The host unit assumes the standby state by expecting the above described series of data transfers to be completed. A waiting time for deciding the completion of the data transfer needs to be set sufficiently long because it would otherwise be difficult to obtain a satisfactory performance.

The reordering process which changes the execution order of the instructions received by the external storage apparatus in order to improve the processing time, is carried out by a magnetic disk controller in the case of a magnetic disk unit. When a plurality of temporarily held instructions exist and the access locations of the instructions are randomly set, the magnetic disk controller carries out the reordering process to execute the instructions with a high efficiency. Presently, such a reordering process is generally used as a method of processing the instructions of the host unit at a high speed.

However, because of the increased storage capacity of the magnetic disk unit and increased recording density of the magnetic disk used in the recent magnetic disk units, the effects of extremely small noise in the magnetic disk unit have become more notable, and there are increased number of cases where the access to the magnetic disk of the magnetic disk unit cannot be processed in one try. In such cases, a recovery process is carried out a specified number of times in the magnetic disk unit. When an error is detected, various recovery processes including retry processes are carried out at the location where the error was detected, so that the specified instruction can be executed.

Since the retry process is carried out depending on the location where the error was detected, when the error is detected and the retry process is to be carried out, it is necessary to wait, for a rotation wait time, until the magnetic disk rotates and the head reaches the same location on the magnetic disk where the error was detected, due to the operation of the magnetic disk unit. The retry is carried out when the same location on the magnetic disk is reached by the head.

For this reason, the above described rotation wait time is inevitably generated when the retry process is carried out. Consequently, the effects of this rotation wait time is becoming no longer negligible even when the instruction of the host unit is processed at a high speed.

Particularly as the storage capacity of the magnetic disk unit becomes higher and the track density on the magnetic disk becomes higher, the required accuracy with which the head is positioned on a target track of the magnetic disk becomes higher. As a result, the effects of the head positioning process of the magnetic disk unit is also becoming no longer negligible. Due to an external force applied on an actuator which affects the head positioning accuracy, when the head provided on a tip end of the actuator is positioned to stop at the target track, an unnecessarily large load is applied to brake the head, and it has been found that extremely small vibrations are caused thereby. In addition, because signals induced by such vibrations do not match predetermined frequencies of electronic parts within the magnetic disk unit which convert the signals reproduced from the magnetic disk, errors are generated thereby to cause the retry process described above.

It may be considered that the above described problems are dependent on the moving distance of the actuator and the external force applied on the actuator. However, the external force applied on the actuator is largely dependent on the individual parts which utilize a spring mechanism and are mounted on the actuator. The present inventor has found that the external force may be recognized as an element which is reflected to the moving direction of the head in the magnetic disk unit. The moving direction of the head includes two kinds, namely, a positive direction and a negative direction, as will be described later. In this specification, the “direction” refers to the moving direction of the head.

### SUMMARY OF THE INVENTION

Accordingly, it is a general object of the present invention to provide a novel and useful reordering controller, reordering method and storage apparatus, in which the problems described above are eliminated.

Another and more specific object of the present invention is to provide a reordering controller and a reordering method which take into account a dependency of the “direction” and the retry process and reflect this dependency to the reordering process so that the instruction may be processed at a high speed, and a high-performance storage apparatus which employs such a reordering controller or reordering method.

Still another object of the present invention is to provide a reordering controller for reordering an execution order of instructions, comprising processing means for carrying out an instruction rearranging process to rearrange the instructions and reorder the execution order of the instructions depending on a state of a restoration process in a storage apparatus. According to the reordering controller of the present invention, a dependency of the “direction” and the retry process are taken into consideration and this dependency is reflected to the reordering process, so that it is possible to process the instructions at a high speed.

A further object of the present invention is to provide a reordering method for reordering an execution order of instructions, comprising the step of (a) carrying out an instruction rearranging process to rearrange the instructions and reorder the execution order of the instructions depending on a state of a restoration process in a storage apparatus. According to the reordering method of the present invention, a dependency of the “direction” and the retry process are taken into consideration and this dependency is reflected to the reordering process, so that it is possible to process the instructions at a high speed.

Another object of the present invention is to provide a storage apparatus comprising processing means for carrying out an instruction rearranging process to rearrange instructions and reorder an execution order of the instructions depending on a state of a restoration process. According to the storage apparatus of the present invention, a dependency of the “direction” and the retry process are taken into consideration and this dependency is reflected to the reordering process, so that it is possible to process the instructions at a high speed, thereby realizing a high performance.

The state of the recovery process may be managed for each direction in which a head is positioned with respect to a recording medium within the storage apparatus. In this case, the state of the recovery process may be managed for each access to the recording medium or, for each magnitude of the positioning or, by taking into account a number of times the recovery process is carried out. In addition, the state of the recovery state which is managed may be stored in the recording medium or non-volatile storage means.

Therefore, according to the present invention, it is possible to suppress performance deterioration of the storage apparatus such as a magnetic disk unit by optimizing the execution order of the instructions depending on the state of the recovery process such as a retry process, so that the instructions may be processed efficiently. Moreover, by storing the state of the recovery process in a non-volatile memory region of the recording medium or the non-volatile storage means, it is possible to continue using the data related to the state of the recovery process, even when the power of the storage apparatus is turned OFF and thereafter turned ON.

Other objects and further features of the present invention will be apparent from the following detailed description when read in conjunction with the accompanying drawings.

### BRIEF DESCRIPTION OF THE DRAWINGS

FIG. 1 is a system block diagram showing an embodiment of a storage apparatus according to the present invention;

FIG. 2 is a flow chart for explaining a “variable; previous position” update process;

FIG. 3 is a flow chart for explaining a “variable; number of retries in positive direction” and “variable; number of retries in negative direction” update process;

FIG. 4 is a diagram showing rearrangement of instructions according to the prior art and a first embodiment of a reordering method according to the present invention;

FIG. 5 is a flow chart for explaining an instruction rearranging process of the first embodiment of the reordering method;

FIG. 6 is a diagram showing rearrangement of instructions according to the prior art and a second embodiment of the reordering method according to the present invention;

FIG. 7 is a flow chart for explaining an instruction rearranging process of the second embodiment of the reordering method;

FIG. 8 is a flow chart for explaining the instruction rearranging process of the second embodiment of the reordering method;

FIG. 9 is a flow chart for explaining the instruction rearranging process of the second embodiment of the reordering method;

FIG. 10 is a flow chart for explaining the instruction rearranging process of the second embodiment of the reordering method;

FIG. 11 is a diagram showing rearrangement of instructions according to the prior art and a third embodiment of the reordering method according to the present invention; and

FIG. 12 is a flow chart for explaining an instruction rearranging process of the third embodiment of the reordering method.

### DESCRIPTION OF THE PREFERRED EMBODIMENTS

A description will now be given of embodiments of a reordering controller according to the present invention, a reordering method according to the present invention, and a storage apparatus according to the present invention, by referring to the drawings.

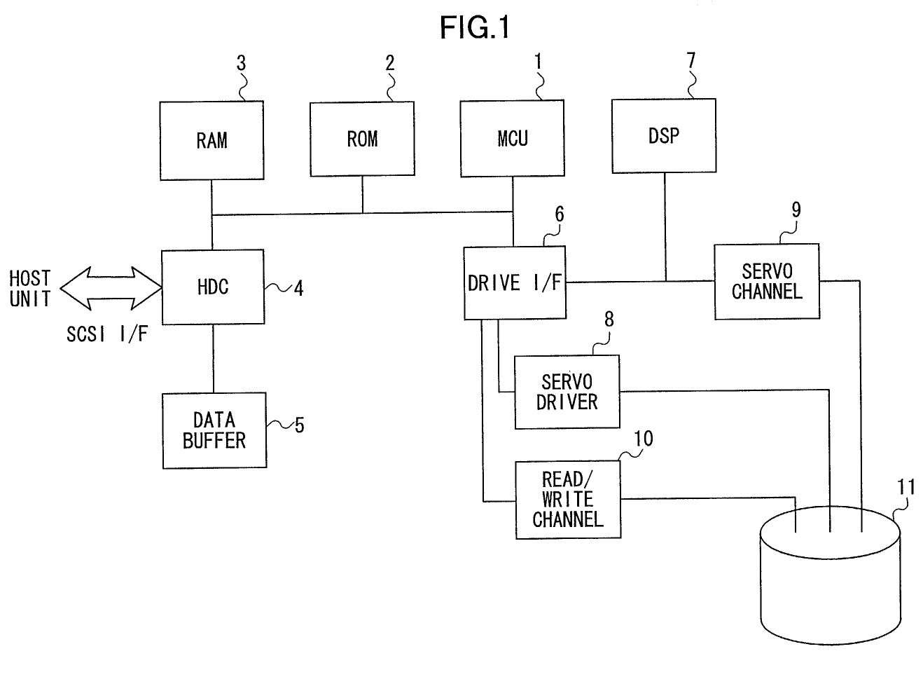

FIG. 1 is a system block diagram showing an embodiment of the storage apparatus according to the present invention. In this embodiment, the present invention is applied to a magnetic disk unit. This embodiment of the storage apparatus employs the reordering controller according to the present invention and the reordering method according to the present invention.

FIG. 1 shows a magnetic disk controller within the magnetic disk unit, together with a magnetic disk section of the magnetic disk unit. A basic structure of the magnetic disk controller shown in FIG. 1 is known, and for the sake of convenience, the illustration of an actuator, a head and the like will be omitted. The magnetic disk unit generally includes a micro-controller unit (MCU) 1, a flash ROM 2, a RAM 3, a hard disk controller (HDC) 4, a data buffer (RAM) 5, a drive interface (I/F) 6, a digital signal processor (DSP) 7, a servo driver 8, a servo channel 9, a read/write channel 10, and a magnetic disk section 11.

The MCU 1 controls the entire operation of the magnetic disk unit. The ROM 2 stores programs to be executed by the MCU 1, data and the like. The RAM 3 stores data such as intermediate data of operations carried out by the MPU 1. The HDC 4 is coupled to a host unit (not shown) via a SCSI interface (I/F), for example, and controls exchange of information between the host unit and the magnetic disk unit. The data buffer 5 is used to temporarily hold information which is exchanged between the host unit and the magnetic disk unit.

The magnetic disk section 11 includes a spindle motor which rotates a magnetic disk, a voice coil motor (VCM) which drives an actuator, a head which is provided on the actuator, and the like. The DSP 7 supplies a control signal for driving and controlling the spindle motor, to the spindle motor via the servo channel 9. In addition, the DSP 7 supplies a control signal for driving and controlling the VCM, to the VCM via the drive interface 6 and the servo driver 8.

A write data from the host unit is temporarily held in the data buffer 5 via the HDC 4, and is supplied to the head of the magnetic disk section 11 via the driver interface 6 and the read/write channel 10, under control of the MCU 1, to be written on the magnetic disk. On the other hand, a read data read from the magnetic disk by the head is temporarily held in the data buffer 5 via the read/write channel 10, the drive interface 6 and the HDC 4, under control of the MCU 1, to be supplied to the host unit via the HDC 4.

In the following description, a “position” refers to a cylinder or a cylinder number on the magnetic disk where the head is positioned.

A firmware of the magnetic disk controller is provided with a memory region for recording the position (variable; previous position) and a memory region for recording a number of times the retry process is carried out for each of the positive and negative directions (variable; number of retries in positive direction and number of retries in negative direction). First, the firmware sets the “variable; previous position” before setting the next position, and records the position to which the head is positioned at this point in time.

The “variable; number of retries in positive direction (negative direction)” is a variable which is updated only when the retry process is started. Whether the “direction” is the positive direction or the negative direction is obtained by referring to the position to which the head is positioned at the start of the retry process (position subject to the retry process) and the value which is recorded in the previous “variable; previous position”, and the “variable; number of retries in positive direction (negative direction)” is updated under this condition.

In a case where the reordering process is carried out when these variables are valid and the magnetic disk controller temporarily holds a plurality of instructions (or commands), a reference is made to the “variable; number of retries” which is provided for each of the positive direction and the negative direction. If the number of retries in the positive direction is smaller than that in the negative direction, for example, the reordering process rearranges the temporarily held instructions so that the “direction” becomes the positive direction.

In each of the embodiments of the reordering method according to the present invention which will be described hereinafter, it is assumed for the sake of convenience that the magnetic disk unit continuously receives write instructions from the host unit and stores a plurality of instructions.

First Embodiment:

First, a description will be given of a method of updating the “variable; number of retries in positive direction (negative direction)” and the “variable; previous position”. Normally, when executing an instruction received from the host unit, the magnetic disk controller first confirms whether or not the received instruction has the logical block address (LBA) format, and obtains a physical address from a value specified by the instruction in the case of the LBA format and sets a predetermined variable thereto. Thereafter, the head is positioned to the physical address, and the access is made to the magnetic disk. The present position of the head is registered in the “variable; previous position” when positioning the head to the next new physical address.

On the other hand, if a write error is detected when a disk access is made and a recovery process is started with respect to the detected write error, the present position and the “variable; previous position” are compared, and the “variable; number of retries in positive direction” or the “variable; number of retries in negative direction” is updated according to the following Conditions 1 and 2. The “variable; number of retries in positive direction” is updated when the Condition 1 is satisfied, and the “variable; number of retries in negative direction” is updated when the Condition 2 is satisfied.

Condition 1: (present position)>“variable; previous position”

Condition 2: (present position)<“variable; previous position”

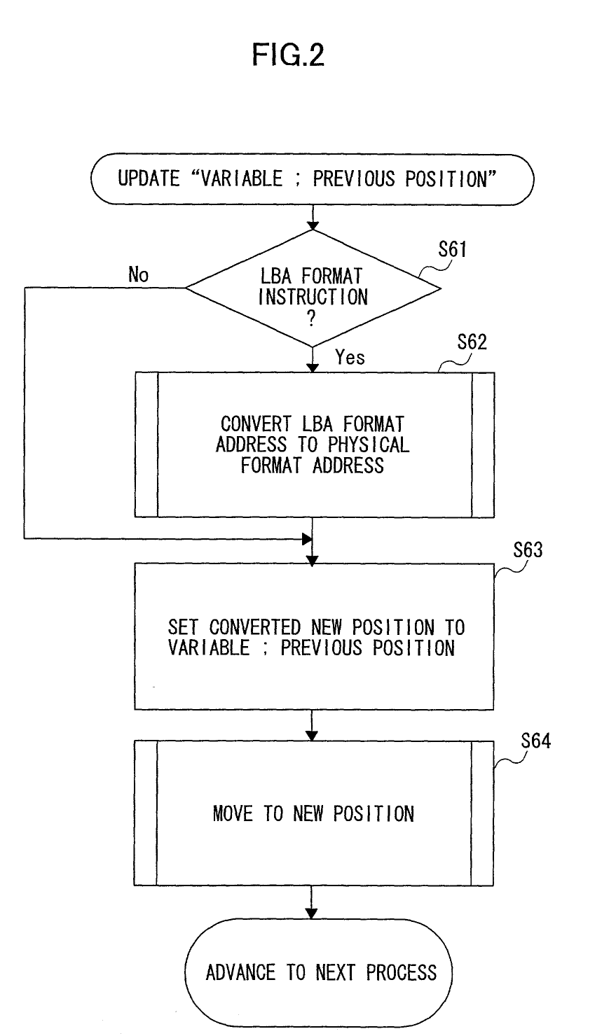

FIG. 2 is a flow chart for explaining a “variable; previous position” update process. The process shown in FIG. 2 is carried out by the MCU 1 shown in FIG. 1.

In FIG. 2, a step S61 decides whether or not the instruction is a LBA format instruction. If the decision result in the step S61 is YES, a step S62 converts the LBA format address into the physical format address. After the step S62 or, if the decision result in the step S61 is NO, a step S63 sets an updated new position (cylinder number) to the “variable; previous position”. In addition, a step S64 moves the head to the new position, and the process ends to advance to a next process.

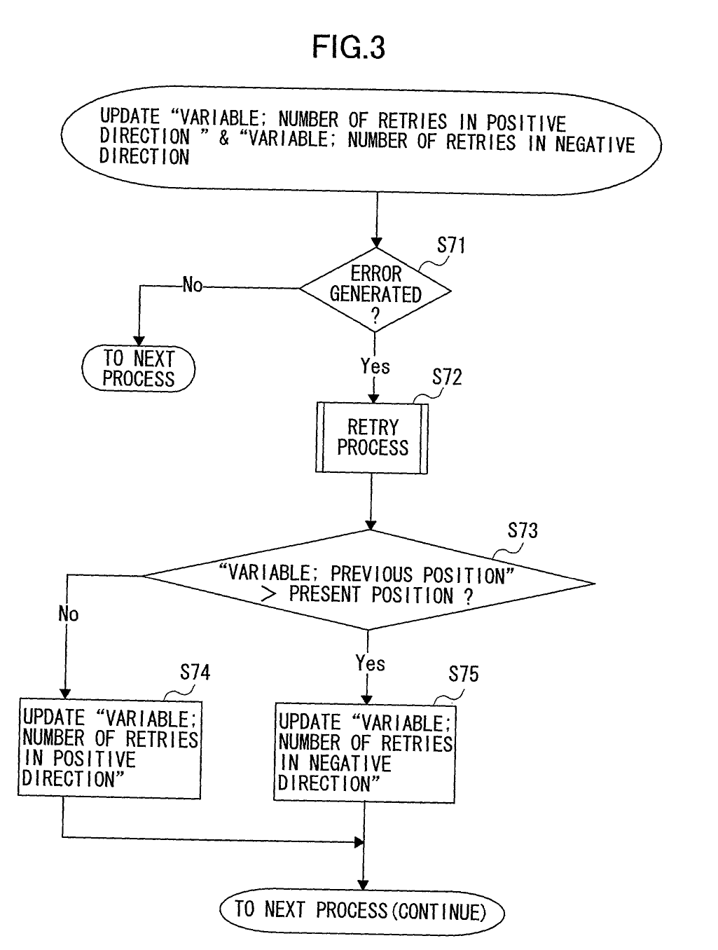

FIG. 3 is a flow chart for explaining a “variable; number of retries in positive direction” and “variable; number of retries in negative direction” update process. The process shown in FIG. 3 is carried out by the MCU 1 shown in FIG. 1.

In FIG. 3, a step S71 decides whether or not an error is generated, and the process ends to advance to a next process if the decision result in the step S71 is NO. On the other hand, if the decision result in the step S71 is YES, a step S72 carries out a retry process. A step S73 decides whether the “variable; previous position” is greater than the “present position”. If the decision result in the step S73 is NO, the Condition 1 described above stands, and a step S74 updates the “variable; number of retries in positive direction”. If the decision result in the step S73 is YES, the Condition 2 described above stands, and a step S74 updates the “variable; number of retries in negative direction”. After the step S74 or S75, the process ends to advance to a next process (continuation of the retry process).

Next, a description will be give of the reordering process which uses the above described variables. The reordering process is started and carried out when positioning the head to a new physical address such as when carrying out a seek process. For the sake of convenience, a description will be given of a case where the magnetic disk controller stores five write instructions. It is further assumed for the sake of convenience that the five write instructions (or commands) WC1 through WC5 instruct the following.

Write instruction WC1: Access a location separated by 25 positions in the positive direction from the present position.

Write instruction WC2: Access a location separated by 20 positions in the positive direction from the present position.

Write instruction WC3: Access a location separated by 15 positions in the positive direction from the present position.

Write instruction WC4: Access a location separated by 8 positions in the negative direction from the present position.

Write instruction WC5: Access a location separated by 13 positions in the negative direction from the present position.

In this case, when the prior art reordering process is carried out, the instructions are rearranged to position the head to a location closest to the present position, and thus, the write instructions WC1 through WC5 are rearranged in the following order.

Order 1: Write instruction WC4

Order 2: Write instruction WC5

Order 3: Write instruction WC3

Order 4: Write instruction WC2

Order 5: Write instruction WC1

However, in this embodiment, the write instructions WC1 through WC5 are rearranged in the following order depending on the set states of the “variable; number of retries in positive direction” and the “variable; number of retries in negative direction”. In other words, the order of the write instructions WC1 through WC5 are rearranged depending on whether the following Condition 3 or 4 is satisfied.

Condition 3: “variable; number of retries in positive direction”>“variable; number of retries in negative direction”

Condition 4: “variable; number of retries in positive direction”<“variable; number of retries in negative direction”

In a case where the Condition 3 is satisfied, the instructions WC1 through WC5 are rearranged as follows. In this case, the “variable; number of retries in negative direction” has a smaller error frequency (number of retries), and the write instructions WC1 through WC5 are rearranged so that the positioning direction becomes the negative direction at all times.

Order 1: Write instruction WC4

Order 2: Write instruction WC5

Order 3: Write instruction WC1

Order 4: Write instruction WC2

Order 5: Write instruction WC3

On the other hand, in a case where the Condition 4 is satisfied, the instructions WC1 through WC5 are rearranged as follows. In this case, the “variable; number of retries in positive direction” has a smaller error frequency (number of retries), and the write instructions WC1 through WC5 are rearranged so that the positioning direction becomes the positive direction at all times.

Order 1: Write instruction WC3

Order 2: Write instruction WC2

Order 3: Write instruction WC1

Order 4: Write instruction WC5

Order 5: Write instruction WC4

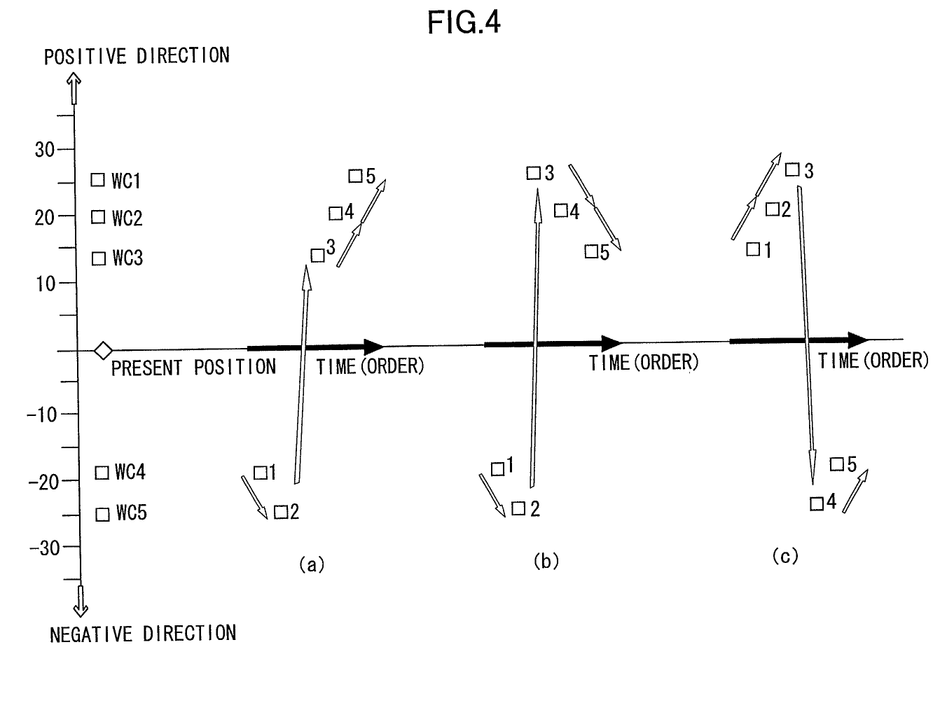

FIG. 4 is a diagram showing rearrangement of the instructions according to the prior art and this first embodiment of the reordering method according to the present invention. In FIG. 4, (a) shows the prior art reordering process, (b) shows the reordering process of this embodiment when the Condition 3 is satisfied, and (c) shows the reordering process of this embodiment when the Condition 4 is satisfied. In FIG. 4, the ordinate indicates the moving direction of the head, with an upward direction corresponding to the positive direction and a downward direction corresponding to the negative direction, and the abscissa indicates the time.

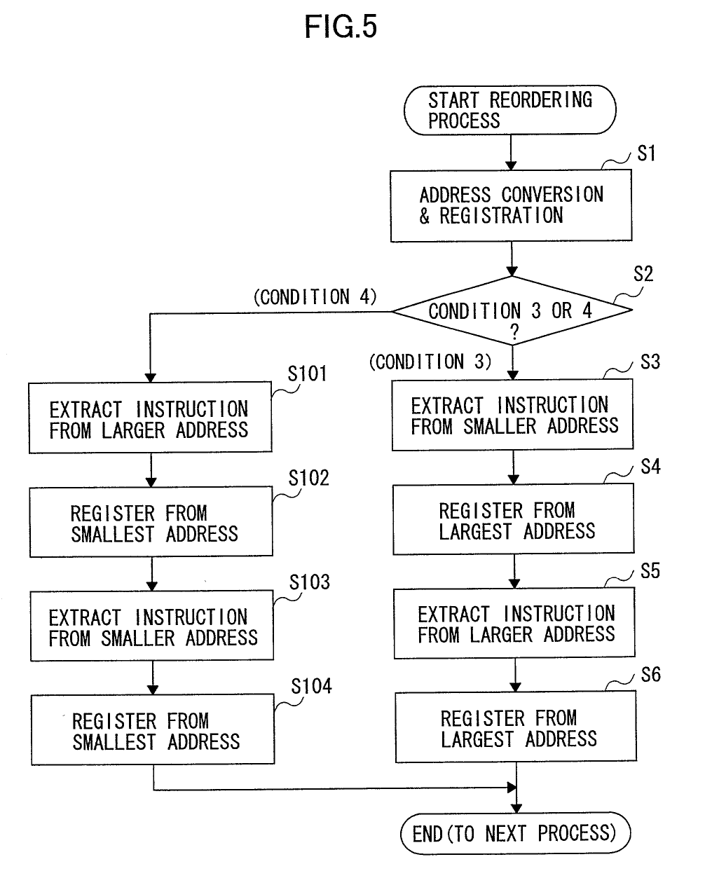

FIG. 5 is a flow chart for explaining an instruction rearranging process of this first embodiment of the reordering method. The process shown in FIG. 5 is carried out by the MCU 1 shown in FIG. 1.

In FIG. 5, a step S1 converts the specified logical address of all of the instructions (write instructions WC1 through WC5 in this particular case) which are being held into the physical address, and successively registers the physical address in an internal list, that is, the variables. A step S2 compares the “variable; number of retries in positive direction” and the “variable; number of retries in negative direction”, and decides whether the Condition 3 or the Condition 4 is satisfied. If the Condition 3 is satisfied in the step S2, a step S3 extracts from within all of the instructions which are being held an instruction which is located at a physical address smaller than that of the present position. A step S4 registers, in an instruction execution order list, the instruction extracted by the step S3 in an order from the largest logical address. A step S5 extracts from all of the instructions which are being held an instruction which is located at a physical address larger than that of the present position. A step S6, registers, in the instruction execution order list, the instruction extracted by the step S5 in an order from the largest logical address, and the process ends.

On the other hand, if the Condition 4 is satisfied in the step S2, a step S101 extracts from within all of the instructions which are being held an instruction which is located at a physical address larger than that of the present position. A step S102 registers, in the instruction execution order list, the instruction extracted by the step S101 in an order from the smallest logical address. A step S103 extracts from all of the instructions which are being held an instruction which is located at a physical address smaller than that of the present position. A step S104, registers, in the instruction execution order list, the instruction extracted by the step S103 in an order from the smallest logical address, and the process ends.

Second Embodiment:

In the first embodiment described above, the write instructions were considered. However, it is possible to take the “variable; number of retries in positive direction (negative direction” with respect to read instructions (commands). In other words, when the above described reordering process is expanded by replacing the variables by “variable; number of retries in positive direction (negative direction) during write” and “variable; number of retries in positive direction (negative direction) during read”, it is possible to reflect more detailed contents to the reordering process.

These variables are updated when the retry process is started, but it is necessary to change the variables which are updated depending on the positioning condition at that point in time, that is, whether the retry process is due to a write access or a read access. Hence, instead of the five write instructions WC1 through WC5 described above, a description will be given of a case where the five instructions (commands) are as follows.

Write instruction WC1: Access a location separated by 25 positions in the positive direction from the present position.

Read instruction RC2: Access a location separated by 20 positions in the positive direction from the present position.

Read instruction RC3: Access a location separated by 15 positions in the positive direction from the present position.

Read instruction RC4: Access a location separated by 8 positions in the negative direction from the present position.

Write instruction WC5: Access a location separated by 13 positions in the negative direction from the present position.

In this case, when the prior art reordering process is carried out, the instructions are rearranged to position the head to a location closest to the present position, and thus, the instructions WC1, RC2, RC3, RC4 and WC5 are rearranged in the following order, similarly to the case described above.

Order 1: Read instruction RC4

Order 2: Write instruction WC5

Order 3: Read instruction RC3

Order 4: Read instruction RC2

Order 5: Write instruction WC1

However, in this embodiment, the instructions WC1, RC2, RC3, RC4 and WC5 are rearranged in the following order depending on the set states of the “variable; number of retries in positive direction during write”, the “variable; number of retries in negative direction during write”, the “variable; number of retries in positive direction during read”, and the “variable; number of retries in negative direction during read”. In other words, the order of the instructions WC1, RC2, RC3, RC4 and WC5 are rearranged depending on whether the following Condition 5, 6 or 7 is satisfied.

Condition 5: Sum of “variable; number of retries in positive direction during write” and “variable: number of retries in positive direction during read”>sum of “variable; number of retries in negative direction during write” and “variable; number of retries in negative direction during read”

Condition 6: “variable; number of retries in positive direction during write”>“variable; number of retries in positive direction during read”

Condition 7: “variable; number of retries in negative direction during write”>“variable; number of retries in negative direction during read”

In a case where the Condition 5 is satisfied, the instructions WC1, RC2, RC3, RC4 and WC5 are rearranged as follows. In this case, the sum of the number of retries in the negative direction, of the “variable; number of retries in negative direction during write” and the “variable; number of retries in negative direction during read” has a smaller error frequency (number of retries), and the instructions WC1, RC2, RC3, RC4 and WC5 are rearranged so that the positioning direction becomes the negative direction at all times. If the Condition 7 is also satisfied, the error frequency (number of retries) becomes even smaller by executing the read instruction, and in this case, the instructions WC1, RC2, RC3, RC4 and WC5 are rearranged so that the read instruction is executed first. After rearranging all of the instructions in the negative direction, the instructions in the positive direction are rearranged by referring to the Condition 6. If it is assumed for the sake of convenience that the Condition 6 is satisfied, the error frequency (number of retries) becomes smaller by executing the read instruction. Hence, the instructions WC1, RC2, RC3, RC4 and WC5 are rearranged so that the read instruction is executed first, and since there are a plurality of read and write instructions in this particular case, the instructions WC1, RC2, RC3, RC4 and WC5 are rearranged by taking into consideration the Condition 5.

Order 1: Read instruction RC4

Order 2: Write instruction WC5

Order 3: Read instruction RC2

Order 4: Read instruction RC3

Order 5: Write instruction WC1

Similarly, the instructions WC1, RC2, RC3, RC4 and WC5 are rearranged as follows if the Condition 5 is not satisfied. In this case, In this case, the sum of the number of retries in the positive direction, of the “variable; number of retries in positive direction during write” and the “variable; number of retries in positive direction during read” has a smaller error frequency (number of retries), and the instructions WC1, RC2, RC3, RC4 and WC5 are rearranged so that the positioning direction becomes the positive direction at all times. If the Condition 6 is also satisfied, the error frequency (number of retries) becomes even smaller by executing the read instruction, and in this case, the instructions WC1, RC2, RC3, RC4 and WC5 are rearranged so that the read instruction is executed first. After rearranging all of the instructions in the positive direction, the instructions in the negative direction are rearranged by referring to the Condition 6. If it is assumed for the sake of convenience that the Condition 6 is satisfied, the error frequency (number of retries) becomes smaller by executing the read instruction. Hence, the instructions WC1, RC2, RC3, RC4 and WC5 are rearranged so that the read instruction is executed first. But since there are only two executing instructions in this embodiment, the effect of the reordering is greater if the position becomes smaller, and thus, the instructions WC1, RC2, RC3, RC4 and WC5 are rearranged so as to execute the read instruction first.

Order 1: Read instruction RC3

Order 2: Read instruction RC2

Order 3: Write instruction WC1

Order 4: Read instruction RC4

Order 5: Write instruction WC5

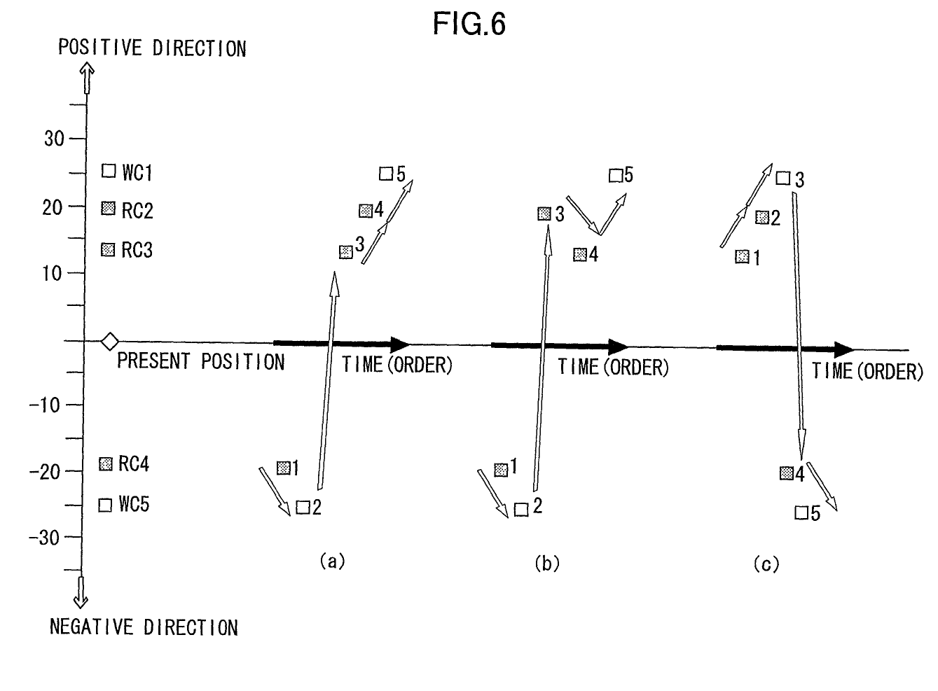

FIG. 6 is a diagram showing rearrangement of instructions according to the prior art and this second embodiment of the reordering method according to the present invention. In FIG. 6, (a) shows the prior art reordering process, (b) shows the reordering process of this embodiment when the Condition 5 is satisfied, and (c) shows the reordering process of this embodiment when the Condition 5 is not satisfied. In FIG. 6, the ordinate indicates the moving direction of the head, with an upward direction corresponding to the positive direction and a downward direction corresponding to the negative direction, and the abscissa indicates the time.

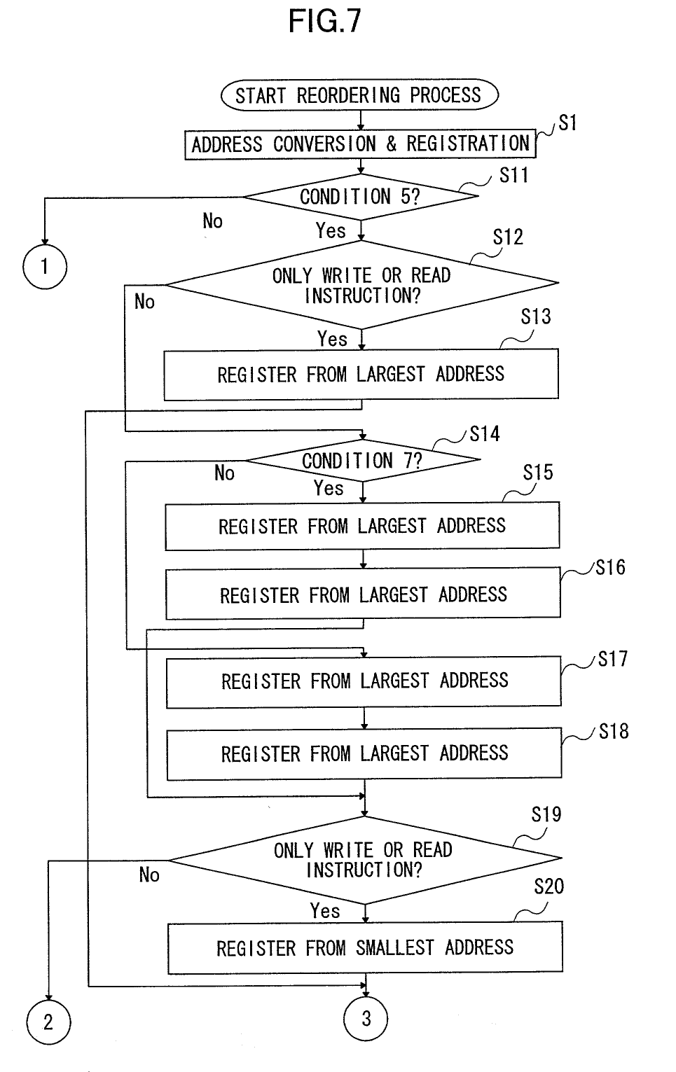

FIGS. 7 through 10 respectively are flow charts for explaining an instruction rearranging process of this second embodiment of the reordering method. The process shown in FIGS. 7 through 10 is carried out by the MCU 1 shown in FIG. 1.

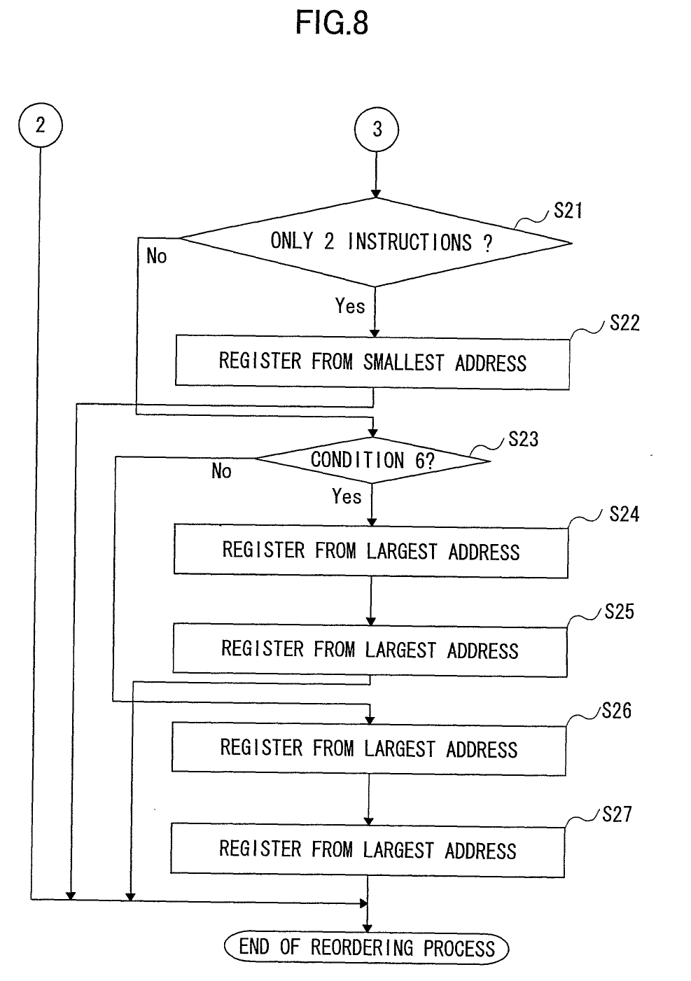

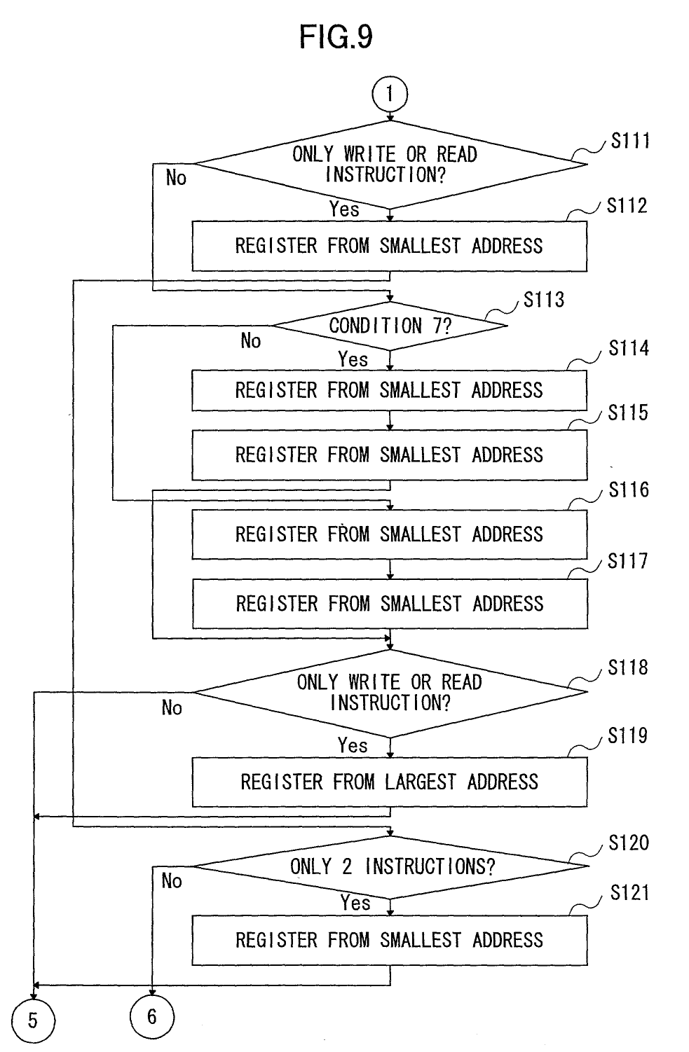

In FIG. 7, a step S1 converts the specified logical address of all of the instructions (write instruction WC1, read instructions RC2 through RC4, and write instruction WC5 in this particular case) which are being held into the physical address, and successively registers the physical address in an internal list, that is, the variables. A step S11 compares a sum total of the “variable; number of retries in positive direction” and a sum total of the “variable; number of retries in negative direction”, and decides whether the Condition 5 is satisfied. If the decision result in the step S11 is NO, the process advances to a step S111 shown in FIG. 9 which will be described later. On the other hand, if the decision result in the step S11 is YES, a step S12 decides whether, of the instructions which are being held, all of the instructions in the negative direction are made up solely of write instructions or made up solely of read instructions. If the decision result in the step S12 is YES, a step S13 registers, in an instruction execution order list, all of the instructions in the negative direction, of all of the instructions which are being held, in an order from the largest logical address. After the step S13, the process advances to a step S21 shown in FIG. 8 which will be described later.

On the other hand, if the decision result in the step S12 is NO, a step S14 compares a case where the write instruction is executed and a case where the read instruction is executed, for the number of retries in the negative direction, and decides whether or not the Condition 7 is satisfied. If the decision result in the step S14 is YES, a step S15 registers, in the instruction execution order list, only the read instructions in the negative direction, of all of the instructions which are being held, in an order from the largest logical address. A step S16 registers, in the instruction execution order list, only the write instructions in the negative direction, of all of the instructions which are being held, in an order from the largest logical address. After the step S16, the process advances to a step S19.

If the decision result in the step S14 is NO, a step S17 registers, in the instruction execution order list, only the write instructions in the negative direction, of all of the instructions which are being held, in an order from the largest logical address. A step S18 registers, in the instruction execution order list, only the read instructions in the negative direction, of all of the instructions which are being held, in an order from the largest logical address. After the step S18, the process advances to the step S19.

The step S19 decides whether, of the instructions which are being held, all of the instructions in the positive direction are made up solely of write instructions or made up solely of read instructions. If the decision result in the step S19 is YES, a step S20 registers, in the instruction execution order list, all of the instructions in the positive direction, of all of the instructions which are being held, in an order from the smallest logical address. After the step S20, the process advances to the step S21 shown in FIG. 8 which will be described later. On the other hand, the process ends as shown in FIG. 8 if the decision result in the step S19 is NO.

In FIG. 8, a step S21 decides whether or not there are only two remaining instructions in the positive direction. If the decision result in the step S21 is YES, a step S22 registers, in the instruction execution order list, all of the instructions in the positive direction, of all of the instructions which are being held, in an order from the smallest logical address, and the process ends. On the other hand, if the decision result in the step S21 is NO, a step S23 compares a case where the write instruction is executed and the read instruction is executed, for the number of retries in the positive direction, and decides whether or not the Condition 6 is satisfied. If the decision result in the step S23 is YES, a step S24 registers, in the instruction execution order list, only the read instructions in the positive direction, of all of the instructions which are being held, in an order from the largest logical address. A step S25 registers, in the instruction execution order list, only the write instructions in the positive direction, of all of the instructions which are being held, in an order from the largest logical address, and the process ends.

If the decision result in the step S23 is NO, a step S26 registers, in the instruction execution order list, only the write instructions in the positive direction, of all of the instructions which are being held, in an order from the largest logical address. A step S27 registers, in the instruction execution order list, only the read instructions in the positive direction, of all of the instructions which are being held, in an order from the largest logical address, and the process ends.

In FIG. 9, a step S111 decides whether, of the instructions which are being held, all of the instructions in the positive direction are made up solely of write instructions or made up solely of read instructions. If the decision result in the step S111 is YES, a step S112 registers, in the instruction execution order list, all of the instructions in the positive direction, of all of the instructions which are being held, in an order from the smallest logical address. After the step S112, the process advances to a step S120 which will be described later.

On the other hand, if the decision result in the step S111 is NO, a step S113 compares a case where the write instruction is executed and a case where the read instruction is executed, for the number of retries in the positive direction, and decides whether or not the Condition 7 is satisfied. If the decision result in the step S113 is YES, a step S114 registers, in the instruction execution order list, all of the read instructions in the positive direction, of all of the instructions which are being held, in an order from the smallest logical address. A step S115 registers, in the instruction execution order list, all of the write instructions in the positive direction, of all of the instructions which are being held, in an order from the smallest logical address. After the step S115, the process advances to a step S118 which will be described later.

If the decision result in the step S113 is NO, a step S116 registers, in the instruction execution order list, only the write instructions in the positive direction, of all of the instructions which are being held, in an order from the smallest logical address. A step S117 registers, in the instruction execution order list, only the read instructions in the positive direction, of all of the instructions which are being held, in an order from the smallest logical address. After the step S117, the process advances to the step S118.

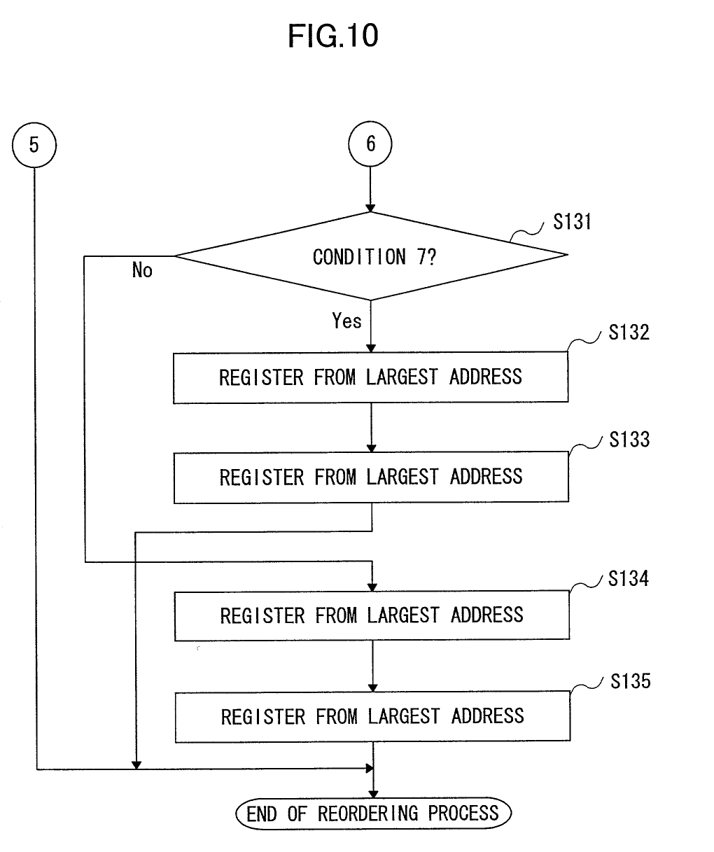

The step S118 decides whether, of the instructions which are being held, all of the instructions in the negative direction are made up solely of write instructions or made up solely of read instructions. If the decision result in the step S118 is YES, a step S119 registers, in the instruction execution order list, all of the instructions in the negative direction, of all of the instructions which are being held, in an order from the largest logical address, and the process ends as shown in FIG. 10. On the other hand, the process ends as shown in FIG. 10 if the decision result in the step S118 is NO.

The step S120 decides whether or not there are only two remaining instructions in the positive direction. If the decision result in the step S120 is YES, a step S121 registers, in the instruction execution order list, all of the instructions in the positive direction, of all of the instructions which are being held, in an order from the smallest logical address, and the process ends as shown in FIG. 10. On the other hand, if the decision result in the step S120 is NO, the process advances to a step S131 shown in FIG. 10.

In FIG. 10, the step 131 compares a case where the write instruction is executed and the read instruction is executed, for the number of retries in the negative direction, and decides whether or not the Condition 7 is satisfied. If the decision result in the step S131 is YES, a step S132 registers, in the instruction execution order list, only the read instructions in the negative direction, of all of the instructions which are being held, in an order from the largest logical address. A step S133 registers, in the instruction execution order list, only the write instructions in the negative direction, of all of the instructions which are being held, in an order from the largest logical address, and the process ends.

If the decision result in the step S131 is NO, a step S134 registers, in the instruction execution order list, only the write instructions in the negative direction, of all of the instructions which are being held, in an order from the largest logical address. A step S135 registers, in the instruction execution order list, only the read instructions in the negative direction, of all of the instructions which are being held, in an order from the largest logical address, and the process ends.

Third Embodiment:

Furthermore, it is possible to reflect more detailed contents to the reordering process if the “variable; number of retries in positive direction (negative direction) during write” and the “variable; number of retries in positive direction (negative direction) during read” are defined for each difference between the “variable; previous position” and the present position. In this case, the memory environment of the firmware becomes limited if the variables are actually defined for each difference, and for this reason, reference data may be managed by defining the variables for each magnitude of the difference. For example, the “variable; number of retries in positive direction during write” is replaced by the following three kinds of variables and defined.

Definition 1: Number of retries in positive direction during write for a difference of up to 10

Definition 2: Number of retries in positive direction during write for a difference of 11 to 20

Definition 3: Number of retries in positive direction during write for a difference of 21 or greater

When the values of each of the variables defined in this manner are added, the same value is obtained as in the case of the “variable; number of retries in positive direction during write”. Definitions similar to those with respect to the above three defined variables are made with respect to the “variable; number of retries in negative direction during write”, the “variable; number of retries in positive direction during read” and the “variable; number of retries in negative direction during read”.

A description will now be given of a case where the magnetic disk controller holds five instructions, similarly to the second embodiment described above.

In this case, when the prior art reordering process is carried out, the instructions are rearranged to position the head to a location closest to the present position, and thus, the instructions WC1, RC2, RC3, RC4 and WC5 are rearranged in the following order, similarly to the case described above.

Order 1: Read instruction RC4

Order 2: Write instruction WC5

Order 3: Read instruction RC3

Order 4: Read instruction RC2

Order 5: Write instruction WC1

However, in this embodiment, the instructions WC1, RC2, RC3, RC4 and WC5 are rearranged in the following order depending on a value of a positioning prediction score. More particularly, the moving difference from the present position is successively calculated, and the “number of retries; variable” which is determined by the kind of disk access and the difference is used as a weighting value which is added to the moving difference so as to obtain the positioning prediction score. This embodiment will be described for a case where the “number of retries; variable” is as follows.

Number of retries in positive direction during write for the difference of up to 10 (variable 1): 1

Number of retries in positive direction during write for the difference from 11 to 20 (variable 2): 2

Number of retries in positive direction during write for the difference of 21 or greater (variable 3): 3

Number of retries in negative direction during write for the difference of up to 10 (variable 4): 11

Number of retries in negative direction during write for the difference from 11 to 20 (variable 5): 12

Number of retries in negative direction during write for the difference of 21 or greater (variable 6): 13

Number of retries in positive direction during read for the difference of up to 10 (variable 7): 21

Number of retries in positive direction during read for the difference from 11 to 20 (variable 8): 22

Number of retries in positive direction during read for the difference of 21 or greater (variable 9): 23

Number of retries in negative direction during read for the difference of up to 10 (variable 10): 31

Number of retries in negative direction during read for the difference from 11 to 20 (variable 11): 32

Number of retries in negative direction during read for the difference of 21 or greater (variable 12): 33

In addition to the above, it is assumed for the sake of convenience that a positioning prediction execution time is obtained in the following manner. In other words, it is assumed that (positioning prediction score)=(moving difference)+(number of retries (weighting value)). When the positioning prediction execution times are the same, the positioning prediction execution time with the smaller moving difference is selected with priority.

Under the above assumptions, the positioning prediction score from the present position is obtained, and a location where the positioning prediction score becomes a minimum is regarded as an optimum condition.

Positioning Prediction Score

Write instruction WC1: 27=25+2 (variable 2)

Read instruction RC2: 42=20+22 (variable 8)

Read instruction RC3: 48=15+33 (variable 12)

Read instruction RC4: 29=8+21 (variable 7)

Write instruction WC5: 24=13+12 (variable 5)<=

Of the above positioning prediction scores, the positioning prediction score with a mark “<=” on the right becomes the minimum value. Hence, the write instruction WC5 is selected, the difference from the position of the write instruction WC5 is obtained, and the positioning prediction score is obtained as follows to obtain the optimum condition.

Positioning Prediction Score

Write instruction WC1: 41=38+3 (variable 3)

Read instruction RC2: 56=33+23 (variable 9)

Read instruction RC3: 51=28+23 (variable 9)

Read instruction RC4: 26=5+21 (variable 7)<=

In this case, the positioning prediction score with the mark “<=” on the right becomes the minimum value, and the read instruction RC4 is selected. Next, the difference from the position of the read instruction RC4 is obtained similarly to the above, and the positioning prediction score is obtained as follows to obtain the optimum condition.

Positioning Prediction Score

Write instruction WC1: 36=33+3 (variable 3)<=

Read instruction RC2: 51=28+23 (variable 9)

Read instruction RC3: 46=23+23 (variable 9)

In this case, the positioning prediction score with the mark “<=” on the right becomes the minimum value, and the write instruction WC1 is selected. Next, the difference from the position of the write instruction WC1 is obtained similarly to the above, and the positioning prediction score is obtained as follows to obtain the optimum condition.

Positioning Prediction Score

Read instruction RC2: 36=5+31 (variable 10)<=

Read instruction RC3: 41=10+31 (variable 10)

In this case, the positioning prediction score with the mark “<=” on the right becomes the minimum value, and the read instruction RC2 is selected. Thereafter, the read instruction RC3 is finally selected. Accordingly, the selected execution order of the instructions becomes as follows.

Order 1: Write instruction WC5

Order 2: Read instruction RC4

Order 3: Write instruction WC1

Order 4: Read instruction RC2

Order 5: Read instruction RC3

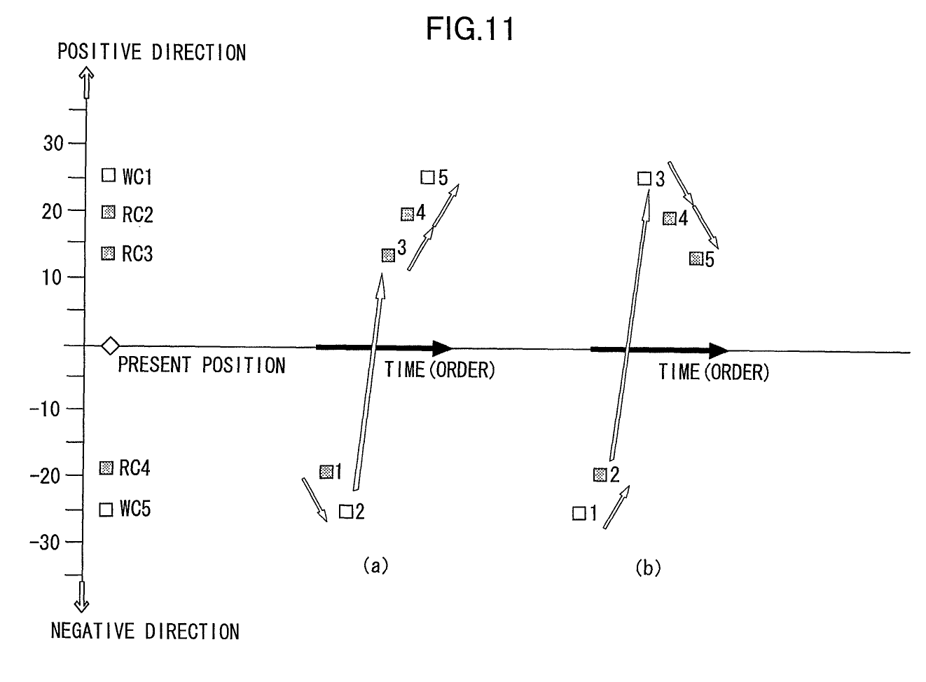

FIG. 11 is a diagram showing rearrangement of instructions according to the prior art and a third embodiment of the reordering method according to the present invention. In FIG. 11, (a) shows the prior art reordering process, and (b) shows the reordering process of this third embodiment. In FIG. 11, the ordinate indicates the moving direction of the head, with an upward direction corresponding to the positive direction and a downward direction corresponding to the negative direction, and the abscissa indicates the time.

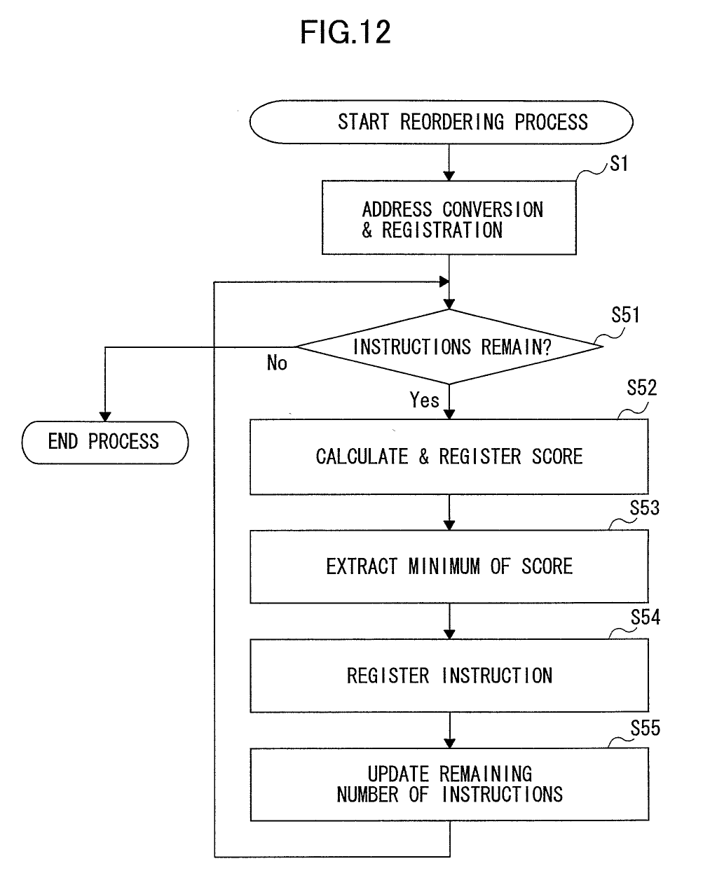

FIG. 12 is a flow chart for explaining an instruction rearranging process of this third embodiment of the reordering method. The process shown in FIG. 12 is carried out by the MCU 1 shown in FIG. 1.

In FIG. 12, a step S1 converts the specified logical address of all of the instructions (write instruction WC1, read instructions RC2 through RC4, and write instruction WC5 in this particular case) which are being held into the physical address, and successively registers the physical address in an internal list, that is, the variables. A step S51 decides whether or not there is a remaining instruction which is to be subjected to the reordering process. The process ends if the decision result in the step S51 is NO. On the other hand, if the decision result in the step S51 is YES, a step S52 calculates and registers the positioning prediction score for each of the instructions which are to be subjected to the reordering process. A step S53 extracts a minimum value of the positioning prediction scores of each of the instructions. A step S54 registers, in an instruction execution order list, the instruction having the positioning prediction score with the minimum value as the instruction which is to be executed next. A step S55 updates the number of remaining instructions which are to be subjected to the reordering process by decrementing the number of remaining instructions, and the process returns to the step S51.

According to this third embodiment, the variables are defined for three cases, namely, a case where the difference is up to 10, a case where the difference is from 11 to 20, and a case where the difference is 21 or greater. However, the range of the difference may be reduced and the number of cases may be increased, depending on the available memory environment provided the firmware, so that more detailed contents may be reflected to the reordering process.

In addition, the number of retries, for example, may be added to each of the variables (variables 1 through 12) for each of the cases to carry out weighting with respect to each of the variables. The number of retries can be detected when a series of tracking processes ends or, when a process with respect to a specified number of sectors ends. Accordingly, the moving difference may be obtained at the time when the number of retries is detected, so as to add the number of retries made to the variable which suits the condition. The variable may be used in a similar identical to the case of the flow chart shown in FIG. 11 described above. In this case, it is possible to reflect more detailed contents to the reordering process.

Moreover, even if there is only one instruction which is to be executed next, the direction of this instruction may easily generate an error given by the Conditions 3 and 4 described above. In such a case, the head may once be moved to a track adjacent to the target track, and thereafter moved and positioned to the target track, so that the possibility of a retry at the target track is reduced and a more efficient process can be expected. In this case, no media access related to the write or read is carried out when the head is moved to the adjacent track, the head is once moved to the adjacent track on the positive direction side of the target track if the Condition 3 is satisfied, the head is once moved to the adjacent track on the negative direction side of the target track if the Condition 4 is satisfied, and the head is thereafter moved to the target track. As a result, it is possible to move the head in the direction in which the frequency of the retry process is small, when moving the head to the target track.

In addition, the data related to the variables may be stored in the form of a table, in a storage region of the magnetic disk other than the storage region used by the user or, in a nonvolatile storage means such as the RAM 3 shown in FIG. 1. The table may be developed in a predetermined variable region when the power of the magnetic disk unit is turned ON. In this case, even when the power of the magnetic disk unit is turned OFF and the data related to the variables are erased, it is possible to repeatedly use the data in the stored table. On the other hand, when an interface instruction which changes the attribute of the magnetic disk unit is executed or when a failure prediction function of the magnetic disk unit is started, the data related thereto may be stored in a non-volatile region. In this case, the data may be copied from the non-volatile region to a predetermined variable region, so that the copied data are continuously usable as command rearranging data.

Further, the present invention is not limited to these embodiments, but various variations and modifications may be made without departing from the scope of the present invention.

What is claimed is:

1. A reordering controller for reordering an execution order of instructions, comprising:
processing means for carrying out an instruction rearranging process to rearrange the instructions and reorder the execution order of the instructions depending on a state of a restoration process in a storage apparatus.

2. The reordering controller as claimed in claim 1, further comprising:
managing means for managing the state of the recovery process for each direction in which a head is positioned with respect to a recording medium within the storage apparatus.

3. The reordering controller as claimed in claim 2, wherein said managing means manages the state of the recovery process for each access to the recording medium.

4. The reordering controller as claimed in claim 3, wherein said managing means further manages the state of the recovery process for each magnitude of the positioning.

5. The reordering controller as claimed in claim 4, wherein said managing means manages the state of the recovery process by taking into account a number of times the recovery process is carried out.

6. The reordering controller as claimed in claim 2, further comprising:
storing means for storing the state of the recovery process managed by said managing means in the recording medium or non-volatile storage means.

7. A reordering method for reordering an execution order of instructions, comprising the step of:
(a) carrying out an instruction rearranging process to rearrange the instructions and reorder the execution order of the instructions depending on a state of a restoration process in a storage apparatus.

8. The reordering method as claimed in claim 7, further comprising the step of:
(b) managing the state of the recovery process for each direction in which a head is positioned with respect to a recording medium within the storage apparatus.

9. The reordering method as claimed in claim 8, wherein said step (b) manages the state of the recovery process for each access to the recording medium.

10. The reordering method as claimed in claim 9, wherein said step (b) further manages the state of the recovery process for each magnitude of the positioning.

11. The reordering method as claimed in claim 10, wherein said step (b) manages the state of the recovery process by taking into account a number of times the recovery process is carried out.

12. The reordering method as claimed in claim 8, further comprising the step of:
(c) storing the state of the recovery process managed by said step (b) in the recording medium or non-volatile storage means.

13. A storage apparatus comprising:
processing means for carrying out an instruction rearranging process to rearrange instructions and reorder an execution order of the instructions depending on a state of a restoration process.

14. The storage apparatus as claimed in claim 13, further comprising:
a head which records and/or reproduces information with respect to a recording medium; and
managing means for managing the state of the recovery process for each direction in which said head is positioned with respect to the recording medium.

15. The storage apparatus as claimed in claim 14, wherein said managing means manages the state of the recovery process for each access to the recording medium.

16. The storage apparatus as claimed in claim 15, wherein said managing means further manages the state of the recovery process for each magnitude of the positioning.

17. The storage apparatus as claimed in claim 16, wherein said managing means manages the state of the recovery process by taking into account a number of times the recovery process is carried out.

18. The storage apparatus as claimed in claim 14, further comprising:
storing means for storing the state of the recovery process managed by said managing means in the recording medium or non-volatile storage means.

19. The storage apparatus as claimed in claim 14, further comprising:
control means for controlling said head so that said head is once moved to a position adjacent to a target position on the recording medium and thereafter moved to the target position.
